(19) United States
(12) Patent Application Publication
(10) Pub. No.: US 2010/0168902 A1
(43) Pub. Date: Jul. 1, 2010

(54) MONEY HANDLING MACHINE

(75) Inventor: Yoshikatsu Mizushima, Hyogo (JP)

Correspondence Address: FOLEY AND LARDNER LLP;SUITE 500, 3000 K STREET NW, WASHINGTON, DC, 20007, US

(73) Assignee: GLORY LTD.

(21) Appl. No.: 12/663,965

(22) PCT Filed: Jun. 11, 2007
(86) PCT No.: PCT/JP2007/061735

§ 371 Date: Dec. 10, 2009

(51) Int. Cl. G06F 7/00; G07D 11/00

(52) U.S. Cl. 700/214; 194/215

(57) ABSTRACT

A money handling machine of the present invention that includes a storing unit for storing money and that performs depositing processing for transporting and storing supplied money in the storing unit, further includes: limit setting unit that sets a storage limit level for the storing unit; storage limit determination unit that determines, when the money stored in the storing unit reaches the storage limit level set for the storing unit, the limitation of storage; and deposit stopping unit that stops the depositing processing according to a result obtained by determination by the storage limit determination unit. Here, the limit setting unit includes a setting storage portion that stores the storage limit level, and performs the setting based on contents stored in the setting storage portion, and the setting can be changed by varying the stored contents. Thus, a money handling machine is provided that can easily adjust, as appropriate, the storage limit level without need to replace a ROM or the like.

### TECHNICAL FIELD

The present invention relates to a money handling machine that performs processing such as for depositing money such as banknotes and coins.

### BACKGROUND ART

Conventionally, in the window of a financial institution or the like, a money handling machine is used that is disclosed in, for example, patent document 1 and that performs depositing processing, dispensing processing and other types of processing. In the money handling machine, for example, when depositing processing is performed, money set in a depositing inlet is transported to a storing unit and stored therein.

On the other hand, when money is stored in the storing unit beyond the allowable capacity (storage limit level), the money is likely to be damaged, the storing unit is likely to be broken and other problems are likely to occur due to excessive storage. For this reason, the number of banknotes that are transported to the storing unit and the amount of money that is stored in the storing unit are monitored, and thus money is prevented from being stored beyond the storage limit level.

In patent document 2, in view of variations in storage amount due to differences in the state of money, the storage amount is determined from the upper limit value of the storage amount and information acquired through sensors, and the storage amount thus calculated is compared with the amount of money that is actually stored in the storing unit, with the result that whether or not the storing unit is full is detected.

Patent document 1: JP-A-2004-145600

Patent document 2: JP-A-H 11-272921

### DISCLOSURE OF THE INVENTION

### Problems to be Solved by the Invention

In the money handling machine described above, the storage limit level is stored in a ROM that is non-rewritable, and the value thereof is fixed. However, for example, in the case of banknotes, when new banknotes are compared with circulated banknotes, it is found that there are more wrinkles and creases in the circulated banknotes (in a poor state). As banknotes are in a poorer state, they are more unlikely to make intimate contact with each other, gaps between the banknotes are increased and other phenomena occur, with the result that even the storing unit having the same capacity actually has a reduced storage limit level. Thus, when the storage limit level is fixed, it is difficult to detect the limit of storage in consideration of differences between new banknotes and circulated banknotes.

Even in banknotes having the same thickness, their individual states may be different depending on countries where the banknotes are used. Hence, when money handling machines that incorporate a storing unit of the same storage capacity are introduced into a plurality of countries, ROMs are required in which the storage limit levels is set according to the countries. However, in this case, since it is necessary to prepare a plurality of types of ROMs and to change or replace the ROM at the start of the use of the money handling machine, disadvantages are encountered in product control, manufacturing cost and the like.

Even in banknotes having the same thickness and used in the same country, as their usage frequency is higher and their denomination is relatively lower, their states are generally poorer. This also causes the actual storage limit level to be varied.

In view of the foregoing problems, the present invention has an object to provide a money handling device in which its storage limit level can be easily adjusted as appropriate without the need to replace a ROM or the like.

### Means for Solving the Problem

To achieve the above object, according to one aspect of the present invention, there is provided a money handling machine that includes a storing unit for storing money and that performs depositing processing for transporting and storing supplied money in the storing unit, the money handling machine including: a limit setting unit that sets a storage limit for the storing unit; a storage limit determination unit that determines the limit of storage when the money stored in the storing unit reaches the storage limit set for the storing unit; and a deposit stopping unit that stops the depositing processing according to a determination result obtained by the storage limit determination unit, in which the limit setting unit includes a setting memory portion that stores the storage limit, and performs the setting based on contents stored in the setting memory portion, and the setting can be changed by changing the stored contents (a first configuration).

With this configuration, in the money handling machine that stops the depositing processing according to a result obtained by determination by the storage limit determination unit, the setting of the storage limit can be changed by varying (rewriting) the contents stored in the setting storage portion. Thus, it is possible to easily adjust, as appropriate, the storage limit of the storing unit without the need to, for example, replace a ROM or the like.

According to another aspect of the present invention, there is provided a money handling machine that includes a depositing portion for receiving money, a storing unit for storing money and a transport portion for transporting money from the depositing portion to the storing unit and that transports and stores the money received by the depositing portion in the storing unit, the money handling machine including: a limit setting unit that sets a storage limit for the storing unit; and a deposit stopping unit that determines whether or not the money stored in the storing unit reaches the storage limit set for the storing unit, and that stops the transport according to a determination result, in which the limit setting unit includes a setting memory portion that stores the storage limit, and performs the setting based on contents stored in the setting memory portion, and the setting can be changed by changing the stored contents (a second configuration).

With this configuration, in the money handling machine that stops the depositing processing according to a result obtained by determining whether or not the money stored in the storing unit reaches the storage limit which is set, the setting of the storage limit can be changed by varying (rewriting) the contents stored in the setting storage portion. Thus, it is possible to easily adjust the storage limit of the storing unit, as appropriate, without the need to, for example, replace a ROM or the like.

In the first configuration, the storage limit determination unit may count money transported to the storing unit, and may compare a counting result with the storage limit and thereby determines whether or not the storage reaches the limit (a third configuration).

With this configuration, by using the device that counts the transported money, it is possible to easily realize storage limit determination unit. It is also possible to express the limit storage as the number of pieces of money or the mass (or the weight) of the money. Here, the “counting” refers not only to the counting of the number of pieces of money but also the counting (adding) of the weight value.

In the first configuration, the money handling machine may include a plurality of denomination-specific storing units that store the supplied money by denomination; the limit setting unit sets the storage limit for each of the denomination-specific storing units; and the storage limit determination unit may determine the storage reaches the limit when money stored in any of the denomination-specific storing units reaches the storage limit set for the denomination-specific storing unit (a fourth configuration).

With this configuration, even in the money handling machine that has the denomination-specific storing units for storing money on a denomination-by-denomination basis, it is possible to easily adjust, as appropriate, the storage limit of the storing unit.

In the fourth configuration, the limit level setting unit can operate selectively in at least any of individual setting in which the storage limit is individually set for each of the denomination-specific storing units, and collective setting in which the storage limit is collectively set for the denomination-specific storing units, to be performed (a fifth configuration).

With this configuration, since the setting of the storage limit can be performed by selecting at least any of the individual setting and the collective setting, it is possible to easily perform the setting of the storage limit. The “collectively setting” means that, by using information with which the storage limit for each of the denomination-specific storing units can be determined, each storage limit is set at the determined storage limit.

In the fourth configuration, the limit setting unit may store a plurality of types of collective setting information that is used for determining the storage limit for each of the denomination-specific storing units, and perform, based on any of collective setting information, collective setting in which the storage limit is collectively set for each of the denomination-specific storing units (a sixth configuration).

With this configuration, by previously preparing various types of collective setting information and selecting, as appropriate, a proper type of collective setting information, it is possible to easily set the storage limit.

In the sixth configuration, the money handling machine may further include a communication interface that allows communication with an external device, in which the limit setting unit performs the collective setting based on the collective setting information, which is selected based on information transmitted from the external device (a seventh configuration).

With this configuration, it is possible to control the setting of the storage limit by the side of the external device (such as a communication terminal). Thus, it is possible to more easily perform the setting of the storage limit.

In the seventh configuration, the money handling machine may further include a setting information changing portion that changes, based on the information transmitted from the external device, the collective setting information stored in the limit setting unit (an eighth configuration).

With this configuration, when it is necessary to change the collective setting information, it is possible to control the change by the side of the external device. Thus, it is possible to more easily perform the changing of the collective setting information.

In the sixth configuration, processing for additionally storing a set of collective setting information in the limit setting unit and processing for changing the collective setting information stored in the limit setting unit can be performed (a ninth configuration).

With this configuration, when, depending on the situation, it is necessary to additionally store a separate type of collective setting information or to change the collective setting information, it is possible to handle it.

In the money handling machine of the sixth configuration, each of the plurality of types of collective setting information corresponds to a country where the money handling machine is used (a tenth configuration).

With this configuration, when the money handling machine is used in any of a plurality of countries, it is possible to set the storage limit with the collective setting information corresponding to the country. Thus, it is possible to easily perform the setting of the storage limit.

In the third configuration, the money handling machine may further include a full-state detection unit that detects a size or a weight of whole money stored in the storing unit to detect whether or not the storing unit is full (an eleventh configuration).

With this configuration, the use of the result obtained by the detection by the full-state detection unit makes it easier to prevent money from being excessively stored in the storing unit. The “full state” refers to a state where a predetermined amount of money or more is stored in the storing unit. The “size of an accumulation body” refers to a conception including the thickness (the size) thereof in a direction in which the accumulation is performed.

In a specific configuration of the third configuration, the deposit processing may be stopped when either of a condition in which the storage limit determination unit determines that the storage reaches the limit, or a condition in which the full-state detection unit detects that the storing unit is full, is satisfied (a twelfth configuration).

In the eleventh configuration, the deposit processing may be stopped when either of a condition in which the storage limit determination unit determines that the storage reaches the limit, or a condition in which the full-state detection unit detects that the storing unit is full, is satisfied (a thirteenth configuration). With this configuration, since the conditions under which the depositing processing is stopped are provided from different points of view, it is possible to more accurately stop the depositing processing.

In the thirteenth configuration, when the full-state detection unit may detect the full state before the storage limit determination unit determines the storage reaches the limit, the storage limit determination unit corrects the storage limit that is set, such that the storage limit is changed to a number of pieces of or a weight of money that has been transported to the storing unit at the time the full state is detected (a fourteenth configuration). With this configuration, it is possible to make the setting of the storage limit more appropriate.

In a specific configuration of the first configuration, the storage limit may indicate the number of pieces of or the weight of money (a fifteenth configuration).

In the first configuration, the money handling machine may further include: a recognition portion that recognizes whether or not the supplied money is allowed to be stored in the storing unit, a temporary storing portion that stores money allowed by the recognition portion to be stored in the storing unit, the supplied money being transported to the temporary storing portion in the depositing processing to be temporarily stored therein and thereafter transported to the storing unit; and a transport interruption unit that interrupts transport of the supplied money to the temporary storing portion, when a predetermined amount of money or more is stored in the storing unit and a predetermined amount of money or more is stored in the temporary storing portion (a sixteenth configuration).

With this configuration, when, for example, the transport of money from the temporary storing portion to the storing unit is restricted, money can be prevented as much as possible from being excessively stored in the temporary storing portion.

More specifically, in the sixteenth configuration, the recognition portion may recognize at least the denomination of the supplied money (a seventeenth configuration). The “denomination” refers to the type of money.

In the sixteenth configuration, when the transport of the supplied money to the temporary storing portion is interrupted by the transport interruption unit, first processing for transporting and storing, in the storing unit, the money stored in the temporary storing portion, and second processing for terminating the interruption when a number of pieces of the money stored in the temporary storing portion is equal to or less than a predetermined number, may be performed (an eighteenth configuration).

With this configuration, it is possible not only to interrupt, as appropriate, the transport of money through the transport interruption unit but also to terminate the interruption when the number of pieces of money stored in the temporary storing portion is equal to or less than the predetermined number. Thus, it is possible not only to prevent money from being excessively stored in the temporary storing unit but also to prevent the unsuccessful transport of money to the storing unit as much as possible.

In the sixteenth configuration, when the transport of the supplied money to the temporary storing portion is interrupted by the transport interruption unit, the money handling machine may perform first processing for transporting and storing, in the storing unit, the money stored in the temporary storing portion and, after the first processing is performed, third processing for providing a notification to an outside when the storage limit determination unit determines the storage reaches the limit or the full-state detection unit detects the full state (a nineteenth configuration).

In this configuration, the third processing is performed, and thus a notification that the limitation of storage or the full-state is detected is provided to the outside. This makes it easier for a teller or the like to recognize the situation and properly cope with it such as by completing the depositing processing.

More specifically, in the nineteenth configuration, the money handling machine may further include a display or a sound generation device generating a sound, in which, in the third processing, the notification is provided through the display device or the sound generation device (a twentieth configuration).

In the sixteenth configuration, when the transport of the supplied money to the temporary storing portion is interrupted by the transport interruption unit, the money handling machine may perform first processing for transporting and storing, in the storing unit, the money stored in the temporary storing portion and, after the first processing is performed, depositing completion processing for completing the depositing processing when the storage limit determination unit determines the storage reaches the limit or the full-state detection unit detects the full state; and, in the depositing completion processing, whether or not processing for transporting banknotes equivalent in value to banknotes that have already been stored in the storing unit to a predetermined dispensing outlet is performed is selected (a twenty first configuration).

In this configuration, as the depositing completion processing, any of the processing for transporting, from the storing unit to the dispensing outlet, banknotes equivalent in value to banknotes that have already been stored in the storing unit and the processing for failing to perform the transport is selectably performed. Thus, it is possible to appropriately meet both a requirement of a customer who considers depositing, if part of money to be deposited can be deposited, the money and a requirement of a customer who does not want to deposit money unless all money is deposited.

It is useful to employ a method of controlling a money handling machine that includes a storing unit for storing money and that transports and stores supplied money in the storing unit, the method including: a first step of setting a storage limit such that the storage limit can be changed for the storing unit; a second step of determining whether or not the money stored in the storing unit reaches the storage limit for the storing unit; and a third step of stopping the transport according to a determination result in the second step.

### ADVANTAGES OF THE INVENTION

According to the present invention, in a money handling machine that stops depositing processing according to a result obtained by a determination (as to whether or not money stored in a storing unit reaches a storage limit level that is set) by storage limit determination unit, the setting of the storage limit level is performed based on contents stored in a setting storage portion which is rewritable storage unit.

Thus, it is possible to change the setting of the storage limit level only by rewriting the contents stored in the setting storage portion. Consequently, it is possible to easily adjust, as appropriate, the storage limit level for the storing unit without need to replace a ROM or the like.

### BRIEF DESCRIPTION OF DRAWINGS

FIG. 1 An appearance diagram of a circulation type banknote depositing and dispensing machine according to an embodiment of the present invention;

FIG. 2 A cross-sectional view of the circulation type banknote depositing and dispensing machine according to the embodiment of the invention;

FIG. 3 A diagram showing the control system of the circulation banknote depositing and dispensing machine and higher-ranking terminals;

FIG. 4 A flowchart of processing on an excessive storage prevention function;

FIG. 5 A table on collective setting information;

FIG. 6 A table specifically showing the excessive storage prevention function; and

FIG. 7 A diagram specifically showing the excessive storage prevention function.

### LIST OF REFERENCE SYMBOLS

11 Circulation type banknote depositing and dispensing machine (money handling machine)
12 & 13 Higher-ranking terminals (external devices)
22 Banknote dispensing outlet
23 Banknote depositing inlet
24 Occupation button
34 Transparent shutter
35 Deposited banknote escrow portion (temporary storing portion)
36 Front door
40 Upper unit banknote transport portion
50 Banknote recognition portion (recognition portion)
82 Reject box
83 Denomination-specific banknote storing portion (storing unit, denomination-specific storing unit)
85 Lower unit banknote transport portion
201 Banknote number detection unit
202 Full-state detection unit
203 Storage portion
204 Control portion

### BEST MODE FOR CARRYING OUT THE INVENTION

An embodiment of the present invention will be described below with reference to the accompanying drawings. The configuration of a circulation type banknote depositing and dispensing machine (hereinafter referred to as a “banknote depositing and dispensing machine”) according to this embodiment will be first described.

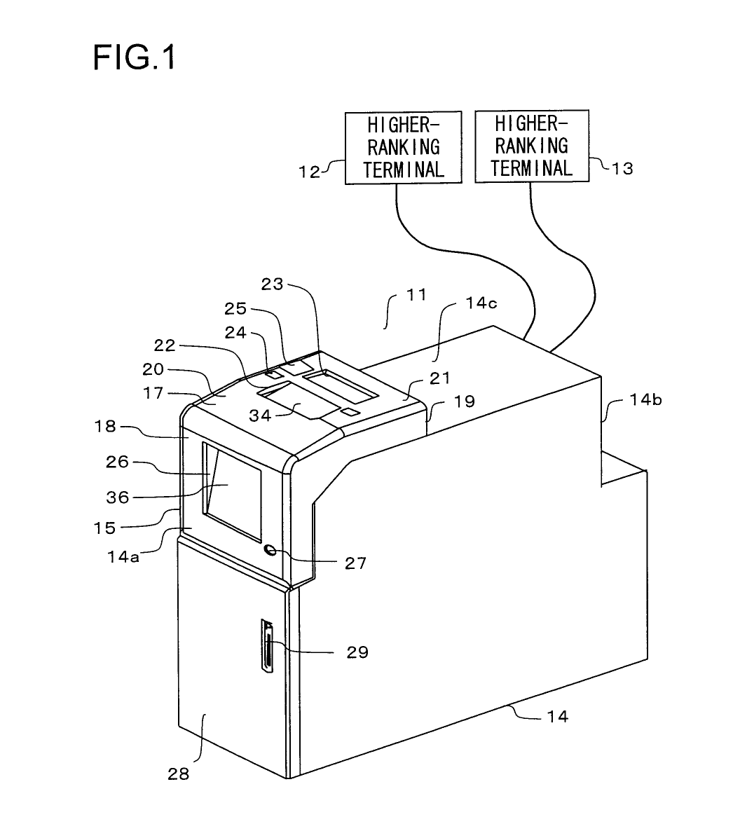

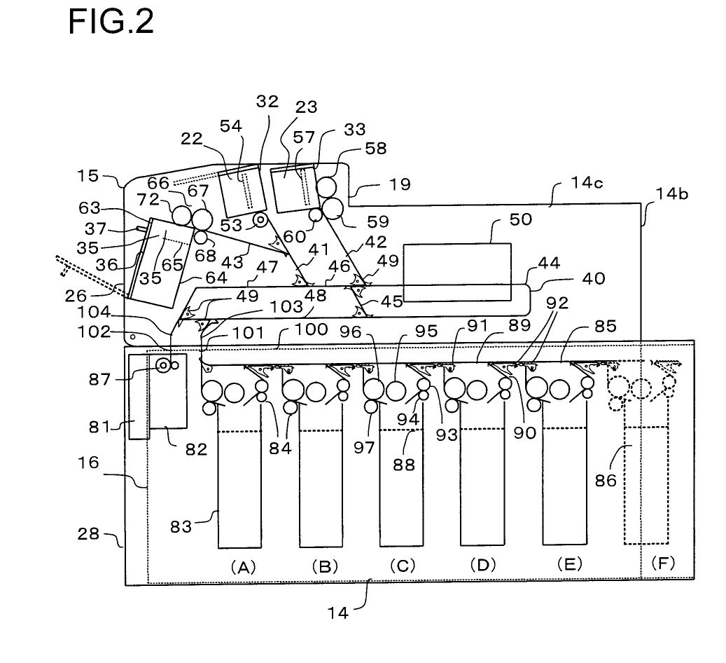

In FIG. 1, an appearance diagram of the circulation type banknote depositing and dispensing machine 11 is shown; in FIG. 2, a cross-sectional view of the banknote depositing and dispensing machine 11 is shown. This banknote depositing and dispensing machine 11 is installed in the counter of a financial institution such as a bank, and specifically is installed between two tellers behind the counter; the depositing and dispensing machine 11 can be used by either or both of the tellers on the left and right of the banknote depositing and dispensing machine 11.

The banknote depositing and dispensing machine 11 is provided with a communication interface; higher-ranking terminals 12 and 13 operated by the two tellers on the left and right are connected to the communication interface. Thus, the higher-ranking terminals 12 and 13 and the banknote depositing and dispensing machine 11 can bi-directionally communicate with each other. There are three ways of using the banknote depositing and dispensing machine 11: only one of the higher-ranking terminals 12 and 13 uses the banknote depositing and dispensing machine 11; and both of them use the banknote depositing and dispensing machine 11.

The banknote depositing and dispensing machine 11 has a main body 14; the main body 14 is configured such that, when an operation surface operated by the tellers is assumed to be a front surface 14a and the opposite surface of the front surface 14a, that is, the surface facing a customer in front of the counter is assumed to be a rear surface 14b, the main body 14 is uprightly mounted with a narrow width in a lateral direction, a wide depth in a forward and backward direction and a long height in a vertical direction.

The main body 14 is provided with an upper unit 15 and a lower unit 16 so that they can be removable from the side of the front surface of the main body 14.

On the front side of the upper surface of and the upper side of the front surface of the upper unit 15, there are arranged an upper surface operation portion 17 and a front surface operation portion 18, respectively, as an operation portion. The upper surface operation portion 17 protrudes upward from the upper surface 14c of the main body 14. A fitting step portion 19 to which a counter fits is formed on an upper surface region of the main body 14 behind the upper surface operation portion 17, the counter having a width dimension equal to a distance from the fitting step portion 19 to the rear surface 14b of the main body 14 is fitted to the upper surface 14c of the main body 14 and the upper surface of the upper surface operation portion 17 is so arranged as to be substantially equal in height to that of the counter.

In the upper surface operation portion 17 of the upper unit 15, that is, in the front side of the upper surface of the main body 14, a slant surface 20 that extends forward and slants downward and a substantially horizontal surface 21 are formed in this order from the front side. In the horizontal surface 21, a banknote dispensing outlet 22 through which banknotes are dispensed and a banknote depositing inlet 23 through which banknotes are deposited are formed in this order from the front side. On the left and right sides of the banknote dispensing outlet 22 and the banknote depositing inlet 23, there are arranged occupation buttons 24 that serve as an occupation indication portion for indicating which one of the tellers on the left and right occupies the depositing processing or the dispensing processing. On one side of the banknote dispensing outlet 22 and the banknote depositing inlet 23, that is, on the left side thereof, there is arranged a display portion 25 that displays a location where a banknote jam occurs and the number of remaining banknotes. The occupation buttons 24 each incorporate a lamp, and the lamp lights when the banknote depositing and dispensing machine 11 is occupied by being operated.

In the front surface operation portion 18 of the upper unit 15, there is formed an opening portion 26 through which banknotes returned due to the non-approval of deposit after deposited banknotes are escrowed at the time of the depositing processing are taken out; the opening portion 26 is blocked by a front door 36. An upper unit lock 27 is provided that is operated by a teller and that is opened and closed with the upper unit 15 housed in the main body 14. The upper unit lock 27 is opened, and thus the upper unit 15 can be removed from the main body 14.

In a lower portion of the front surface of the main body 14, a door member 28 is fitted such that it can be opened and closed. In the door member 28, a lower unit lock 29 is provided that is opened and closed with the lower unit 16 housed in the main body 14 and the door member 28 closed and that can only be operated by a senior manager of a financial institution or a staff member of a security company; the lock of the door member 28 is opened and thus the door member 28 is opened, with the result that it is possible to remove the lower unit 16 out of the main body 14 in a frontward direction. The lower unit lock 29 cannot be opened by a teller.

Below the banknote dispensing outlet 22 and the banknote depositing inlet 23 of the upper unit 15, there are arranged a box-shaped banknote dispensing portion 32 and a box-shaped banknote depositing portion 33, respectively that house a banknote in an upright position with the short edge direction of the rectangular banknote coinciding with a vertical direction. In the banknote dispensing outlet 22, a transparent shutter 34 is arranged such that it can be opened and closed; the transparent shutter 34 closes the banknote dispensing outlet 22 while money is dispensed and opens it at the time of the completion of the dispensing of money; and it is possible to see, through the transparent shutter 34 closed while money is dispensed, banknotes that are being dispensed into the banknote dispensing portion 32.

Inside the opening portion 26 of the front surface of the upper unit 15, that is, in a front side region of the main body 14, there is arranged a deposited banknote escrow portion 35 that receives deposited banknotes recognized to be authentic, that is, deposited authentic banknotes and that collectively escrows the banknotes of different denominations. In the front surface of the deposited banknote escrow portion 35, the transparent front door 36 that is locked by an unillustrated electromagnetic lock with the front door 36 closed is arranged such that it can be opened and closed; since, when the escrowed banknotes are returned, the electromagnetic lock is opened, it is possible to collectively receive, by holding a knob 37 provided in the front door 36 and opening the front door 36 forward from the opening portion 26, the escrowed banknotes at the time of the non-approval of deposit stored in the deposited banknote escrow portion 35 through the opening portion 26.

In the upper unit 15, there is provided an upper unit banknote transport portion 40 that is connected to the banknote dispensing portion 32, the banknote depositing portion 33 and the deposited banknote escrow portion 35 and that transports banknotes. The upper unit banknote transport portion 40 is provided with: a dispensing transport path portion 41 that transport a banknote to the banknote dispensing portion 32; a depositing transport path portion 42 that transports a banknote fed from the banknote depositing portion 33; an escrow transport path portion 43 that is connected to a halfway portion of the dispensing transport path portion 41 and that transports a banknote between the escrow transport path portion 43 and the deposited banknote escrow portion 35; a recognition transport path portion 44 that is folded back from the back to the front into an approximate U-shape and whose one end on the upper side is connected to the banknote transport portion 42; a bypass transport path portion 45 that connects the one end on the upper side of the recognition transport path portion 44 to the other end on the lower side; an escrow dispensing transport path portion 46 that is connected between the dispensing transport path portion 41 and the one end (the upper end of the bypass transport path portion 45) on the upper side of the recognition transport path portion 44; a rejected banknote transport path portion 47 that is connected to the escrow dispensing transport path portion 46 and that extends forward; a storing/dispensing transport path portion 48 that is connected to the other end (the lower end of the bypass transport path portion 45) on the lower side of the recognition transport path portion 44, that extends forward and whose front end is connected to the rejected banknote transport path portion 47.

At least the dispensing transport path portion 41, the escrow transport path portion 43, the recognition transport path portion 44, the escrow dispensing transport path portion 46 and the storing/dispensing transport path portion 48 can reverse the banknote transport direction, that is, can perform the transport in both forward and reverse directions. At the portions connected between the transport path portions 41 to 48, there are provided switching members 49 that switch a direction in which a banknote moves. On the recognition transport path portion 44, there is provided a banknote recognition portion 50 that recognizes the denomination, the authenticity, the fitness and the like of a banknote that is transported. The “denomination” refers to the type of money, the “authenticity” refers to whether or not money is counterfeit (whether it is authentic or counterfeit) and the “fitness” refers to whether or not money meets predetermined criteria (for example, criteria for the degrees of soil and damage) to be appropriate.

The banknote dispensing portion 32 is provided with: a blade roller 53 that feeds banknotes transported through the dispensing transport path portion 41 into the banknote dispensing portion 32 in an upright position on a one-by-one basis; and a tray 54 that receives, in an upright position, the banknotes fed by the blade roller 53 and that moves according to the number of banknotes received so that the position at which the banknotes are received is stationary and that the banknotes are kept in an upright position and placed in proper alignment in a front area.

The banknote depositing portion 33 is provided with: a tray 57 that receives deposited banknotes in an upright position; a kick roller 58 that feeds downward on a one-by-one basis banknotes that are placed in an upright position and in proper alignment by being pushed by the tray 57 which moves at the start of the depositing processing; and a feed roller 59 and a gate roller 60 that hold the banknotes fed by the kick roller 58 to feed them to the depositing transport path portion 42.

In the deposited banknote escrow portion 35, the escrow transport path portion 43 is connected to the upper side of the rear surface thereof, the upper side of the rear surface slants backward and downward and the banknotes are placed, with the sides of the banknotes pointing in a vertical direction, on a collection board 65 that moves up and down within the deposited banknote escrow portion 35 between a front wall 63 serving as the front door 36 and a rear wall 64 that cover an escrow space portion 35a in the deposited banknote escrow portion 35.

The deposited banknote escrow portion 35 is provided with feeding unit 66 that feeds, from the escrow transport path portion 43, deposited banknotes into the deposited banknote escrow portion 35 on a one-by-one basis and that feeds out, when the depositing operation is approved, the escrowed banknotes to the escrow transport path portion 43 on a one-by-one basis. The feeding unit 66 operates together with the collection board 65, which moves up and down with the banknotes thereon. The feeding unit 66 is provided with: a plurality of feed rollers 67 and gate rollers 68 arranged in an axial direction in which banknotes are fed from the escrow transport path portion 43 into the deposited banknote escrow portion 35 and in which banknotes are fed out from the deposited banknote escrow portion 35 to the escrow transport path portion 43; a kick roller 72 that feeds out, when banknotes are fed, the escrowed banknotes placed on the collection board 65 between the feed rollers 67 and the gate rollers 68 on a one-by-one basis.

In the lower unit 16, in the front side region of the main body 14, a removable box 81 that stores a gift certificate and the like is removably arranged, and a reject box 82 that stores rejected banknotes is fixedly arranged.

In a region behind the reject box 82, denomination-specific banknote storing portions 83 that store banknotes denomination by denomination are fixedly arranged in the forward and backward direction as represented by letters (A) to (E) in FIG. 2. Above the denomination-specific banknote storing portions 83, there are arranged banknote receiving and feeding portions 84 that receive and feed banknotes one by one. In a region above the denomination-specific banknote storing portions 83, there is arranged a lower unit banknote transport portion 85 that connects to the banknote receiving and feeding portions 84 to transport the banknotes. In a rearmost portion of the lower unit 16, as represented by the letter (F), there is formed an additional space 86 that allows a denomination-specific banknote storing portion 83 to be additionally provided as required.

In the reject box 82, there is arranged feed-in unit 87 that can feed in banknotes through an upper portion of the reject box 82 on a one-by-one basis.

In the denomination-specific banknote storing portions 83, a collection board 88 is provided such that it can move up and down; banknotes are stored on the collection board 88 with the sides of the banknotes pointing in the vertical direction.

The lower unit banknote transport portion 85 is provided with: a main transport path portion 89 that is arranged along the upper regions of the denomination-specific banknote storing portions 83 in the forward and backward direction; feed-in transport path portions 90 that transport banknotes fed from the main transport path portion 89 into the denomination-specific banknote storing portions 83; and feed-out transport path portions 91 that transport banknotes fed out of the denomination-specific banknote storing portions 83 to the main transport path portion 89. At the portions connected between the transport path portions 89 to 91, there are provided switching members 92 that switch a direction in which a banknote moves. The main transport path portion 89 in the lower unit banknote transport portion 85 can reverse the banknote transport direction, that is, can perform the transport in both forward and reverse directions.

The banknote receiving and feeding portion 84 operates together with the collection board 88, which moves up and down with the banknotes thereon. The banknote receiving and feeding portion 84 is provided with: feed-in rollers 93 and 94 that feed in, when banknotes are stored, banknotes from the feed-in transport path portions 90 onto the collection board 88; a kick roller 95 that feeds out, when banknotes are fed out, banknotes on the collection board 88 on a one-by-one basis; and a feed-out roller 96 and a gate roller 97 that feed out the banknote fed out by the kick roller 95 to the feed-out transport path portions 91.

When banknotes are fed into the denomination-specific banknote storing portion 83, since the height of the upper surface of a stack of banknotes is increased each time a banknote is placed on the collection board 88, the collection board 88 is sequentially lowered to receive the banknote such that the upper surface is kept within a predetermined range. When banknotes are fed out of the denomination-specific banknote storing portion 83, the collection board 88 is raised to press the banknote onto the kick roller 95, and the banknote is fed out by the rotation of the kick roller 95 one by one.

In the main body 14, a plate-shaped cover member 100 is fixed between the upper unit 15 and the lower unit 16 so as to cover the upper surface of the lower unit 16 housed in the main body 14 to block the lower unit 16. In the front end side of the cover member 100, there are formed a first opening portion 101 and a second opening portion 102. In the first opening portion 101, there is arranged a first connection passage portion 103 that connects the front end side of the storing/dispensing transport path portion 48 of the upper unit banknote transport portion 40 to the front end side of the lower unit banknote transport portion 85 and that transports banknotes; in the second opening portion 102, there is formed a second connection passage portion 104 that connects the rejected banknote transport path portion 47 of the upper unit banknote transport portion 40 to the reject box 82 and that transports banknotes.

With these first and second connection passage portions 103 and 104, it is possible to transport banknotes between the upper unit 15 and the lower unit 16 through the first opening portion 101 and the second opening portion 102 of the cover member 100 fixed to the main body 14 with the upper unit 15 and the lower unit 16 removable from the main body 14 being housed in the main body 14 and connected to each other. The first connection passage portion 103 and the second connection passage portion 104 can reverse the banknote transport direction, that is, can perform the transport in both forward and reverse directions.

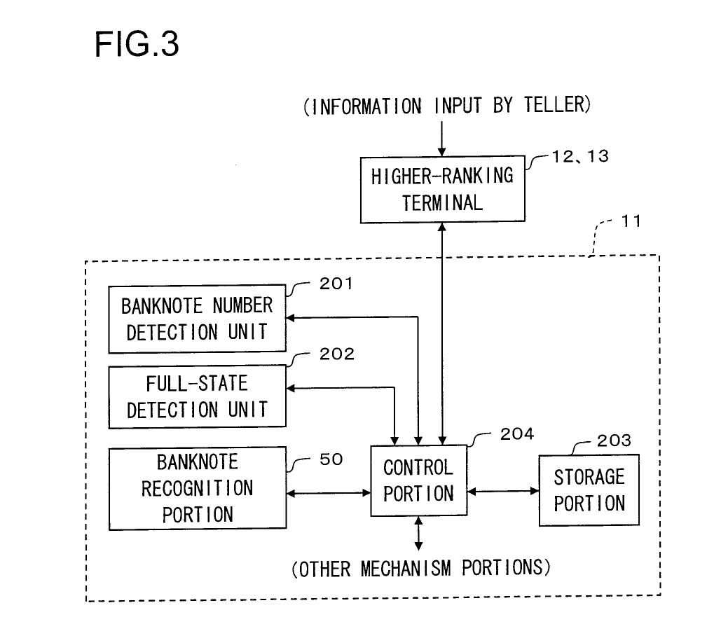

The control system of a system composed of the banknote depositing and dispensing machine 11 and the higher-ranking terminals 12 and 13 will now be described with reference to FIG. 3. As shown in this figure, the banknote depositing and dispensing machine 11 includes not only what are described previously but also banknote number detection unit 201, full-state detection unit 202, a control portion 203 and a storage portion 204.

The banknote number detection unit 201 and the full-state detection unit 202 are provided as unit that detect the number of banknotes stored in each of the denomination-specific banknote storing portions 83 and that detect whether or not each of the denomination-specific banknote storing portions 83 is full. These units are used to realize an excessive storage prevention function, which will be described later.

The banknote number detection unit 201 detects the number of banknotes that are stored in each of the denomination-specific banknote storing portions 83 (or the number of banknotes that are transported to each of the denomination-specific banknote storing portions 83). For example, the banknote number detection unit 201 is provided such as by placing an optical sensor in the feed-in transport path portion 90 of each of the denomination-specific banknote storing portions 83 and counting the number of banknotes that passes through this feed-in transport path portion 90; however, any other method may be employed. The detection information obtained by the banknote number detection unit 201 is transmitted to the control portion 204.

The full-state detection unit 202 physically detects whether or not each of the denomination-specific banknote storing portions 83 is full, through the detection of the size (instead of the size, the weight may be used) of a group of banknotes stored in the denomination-specific banknote storing portion 83. More specifically, since, as described previously, as more banknotes are stored in the denomination-specific banknote storing portion 83, the collection board 88 is lowered, whether or not the denomination-specific banknote storing portion 83 is full is detected by checking whether this collection board 88 is lowered down to a predetermined position.

When the collection board 88 is lowered down to the predetermined position, the full-state detection unit 202 determines that the denomination-specific banknote storing portion 83 is full. Specifically, since, in the denomination-specific banknote storing portion 83, banknotes are stored such that they are sequentially placed on top of each other, whether or not it is full is detected by detecting the height of a stack of banknotes (the thickness in a direction in which the banknotes are placed on top of each other). The detection information obtained by the full-state detection unit 201 is transmitted to the control portion 204.

The storage portion 203 is formed with a rewritable storage device such as a flash memory, and stores various types of information such as collective-setting information and information on a storage limit level. The control portion 204 collectively controls the depositing processing, the dispensing processing and the like performed by the banknote depositing and dispensing machine 11. In controlling them, various types of information are used that are acquired from the higher-ranking terminals 12 and 13, the banknote recognition portion 50, the banknote number detection unit 201, the full-state detection unit 202, the storage portion 203 and the like.

With the banknote depositing and dispensing machine 11 configured as described above, it is possible to perform the banknote depositing processing (processing for internally storing received banknotes), the dispensing processing (processing for taking the specified amount of money out of banknotes stored) and the like. The details of the depositing processing performed in the banknote depositing and dispensing machine 11 will now be described.

When, for example, the teller on the left side uses the banknote depositing and dispensing machine 11, the occupation button 24 on the left side is operated, and thus the banknote depositing and dispensing machine 11 enters the occupation mode in which it is occupied by the teller on the left side.

In the counter of a financial institution, the teller puts deposited banknotes received from a customer into the banknote depositing inlet 23 (the banknote depositing inlet 23 receives the banknotes from the outside), and an operation for starting the depositing of money is performed through the higher-ranking terminal 12 of the teller on the left, with the result that the depositing processing is started.

The deposited banknotes put into the banknote depositing inlet 23 and kept in an upright position are fed out from the banknote depositing inlet 23 to the depositing transport path portion 42 of the upper unit banknote transport portion 40 on a one-by-one basis, and are transported to the recognition transport path portion 44. Then, whether or not each banknote is allowed to be deposited is recognized (for example, with criteria for determining whether the banknote is authentic) by the banknote recognition portion 50.

The deposited banknote that is recognized by the banknote recognition portion 50 to be allowed to be deposited is fed from the recognition transport path portion 44 to the escrow space portion 35a of the deposited banknote escrow portion 35 through the bypass transport path portion 45, the escrow dispensing transport path portion 46, the dispensing transport path portion 41 and the escrow transport path portion 43, and is escrowed.

The deposited banknote (including a banknote that is impossible to recognize) that is recognized by the banknote recognition portion 50 not to be allowed to be deposited is fed from the recognition transport path portion 44 through the bypass transport path portion 45, the escrow dispensing transport path portion 46 and the dispensing transport path portion 41 to the banknote dispensing outlet 22 into an upright position. Then, when the escrow of the deposited banknote is completed, the transparent shutter 34 is opened, and thus the deposited banknote is returned. The banknote that is impossible to recognize is removed from the banknote dispensing outlet 22 by the teller, and then the transparent shutter 34 is closed. The banknote recognized not to be allowed to be deposited is returned by the teller to a customer.

Then, the processing up to the escrow on all the deposited banknotes put into the banknote depositing inlet 23 is completed, and then the recognition result is displayed on the higher-ranking terminal 12 so that whether or not the customer approves the deposing of money is checked.

The teller operates the higher-ranking terminal 12 on a depositing approval instruction, and thereby starts an operation of storing the banknote escrowed in the deposited banknote escrow portion 35. The banknote escrowed in the deposited banknote escrow portion 35, that is, the stored banknote is fed out from the deposited banknote escrow portion 35 to the escrow transport path portion 43 on a one-by-one basis, and is transported through the dispensing transport path portion 41 and the escrow dispensing transport path portion 46 to the recognition transport path portion 44, and then the denomination thereof is recognized by the banknote recognition portion 50. Here, whether or not the stored banknote is authentic may also be recognized.

The stored banknote whose denomination is recognized by the banknote recognition portion 50 is transported from the storing/dispensing transport path portion 48 through the first connection passage portion 103 to the main transport path portion 89 of the lower unit banknote transport portion 85, and is fed from the main transport path portion 89 through the feed-in transport path portion 90 corresponding to the denomination into the corresponding denomination-specific banknote storing portion 83, with the result that it is collected and stored therein. When the banknote is stored in the denomination-specific banknote storing portion 83, the excessive storage prevention function functions so as to avoid a failure in which banknotes are excessively stored. This excessive storage prevention function will be described in detail later.

The teller operates the higher-ranking terminal 12 on a depositing non-approval instruction to release the electromagnetic lock that locks the front door 36 of the deposited banknote escrow portion 35. The teller opens the front door 36 forward from the opening portion 26 of the main body 14 with the knob 37 held by hand, and collectively takes out the banknotes escrowed in the deposited banknote escrow portion 35. Then, the banknotes are returned to the customer, and the front door 36 is closed.

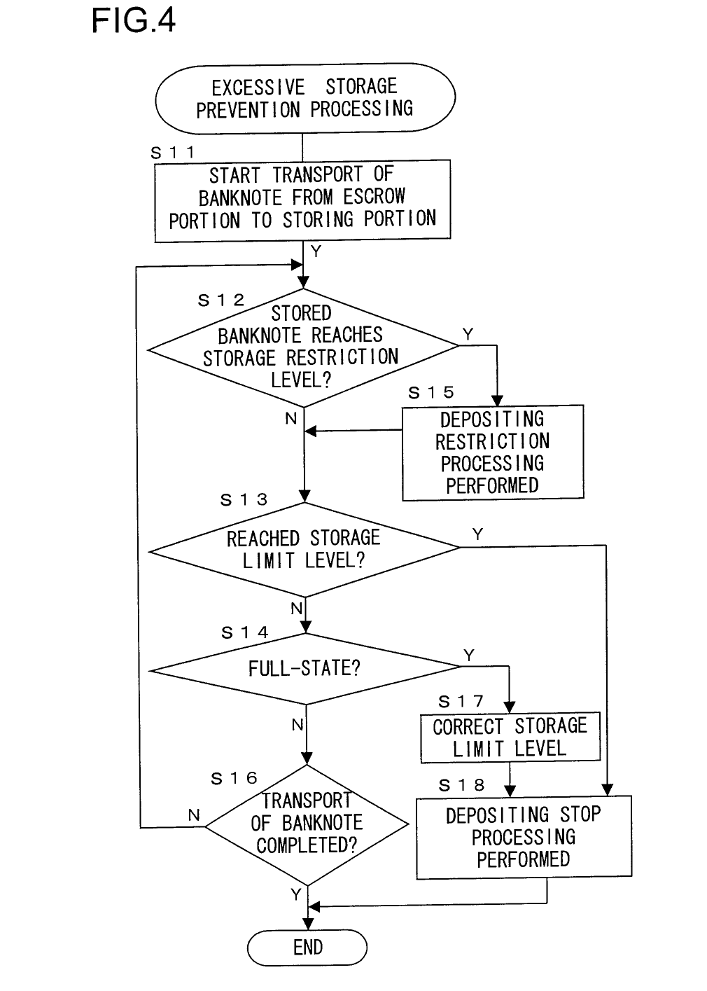

A series of types of processing described above are performed, and thus the depositing processing is achieved. As described previously, the banknote depositing and dispensing machine 11 is provided with the excessive storage prevention function for preventing banknotes from being excessively stored in the denomination-specific banknote storing portions 83. Processing performed by the excessive storage prevention function will be described below with reference to a flowchart shown in FIG. 4. Here, the remaining steps of the processing performed after the banknote that is determined to be authentic is escrowed in the deposited banknote escrow portion 35 will now be described.

The banknote escrowed in the deposited banknote escrow portion 35 is transported to the denomination-specific banknote storing portion 83. During the transport of the banknote, the banknote number detection unit 201 monitors whether or not the number of banknotes stored in each of the denomination-specific banknote storing portions 83 reaches a storage restriction level set for each of the denomination-specific banknote storing portions 83 (step S12). Then, if it reaches the storage restriction level (yes in step S12), depositing restriction processing, which will be described later, will be performed (step S15).

In consideration of the capacity of the denomination-specific banknote storing portion 83, the storage restriction level is previously set at about the number of banknotes at which the remaining capacity is very small. For example, in general, when the storing portion has a capacity of storing about 1500 banknotes, the storage restriction level is set at 900 banknotes. The storage restriction level may be freely varied by the teller.

As in step S12, during the transport of the banknote, the banknote number detection unit 201 monitors whether or not the banknotes stored in any of the denomination-specific banknote storing portions 83 reach the storage limit level (step S13). The full-state detection unit 202 monitors whether or not any of the denomination-specific banknote storing portions 83 is full (step S14). Consequently, if either it reaches the storage limit level or it is full (yes in step S13 or S14), depositing stop processing, which will be described later, will be performed (step S18).

The monitoring in steps S12 to S14 described above is continuously performed until the completion of the transport of the banknotes (until the completion of the transport of all the banknotes) from the deposited banknote escrow portion 35 to the denomination-specific banknote storing portions 83 (step S16).

Here, the storage limit level is the number of banknotes at which the denomination-specific banknote storing portion 83 is considered to be full; the storage limit level can be freely set through the higher-ranking terminal 12 or 13 by the teller. Even after the storage limit level is set, it is possible to set it again by varying the details of the setting. In the method of setting the storage limit level, it is possible to freely select either individual setting or collective setting.

In the individual setting, the storage limit level is individually set for each of the denomination-specific banknote storing portions 83. This individual setting is effective especially when, for example, only in some of the denomination-specific banknote storing portions 83, the storage limit level is desired to be reset.

For example, when, among a plurality of denomination-specific banknote storing portions 83, the storage limit level for the Nth denomination-specific banknote storing portion 83 is set, the ordinal number of the “Nth” storing portion and the value of the storage limit level are specified through the higher-ranking terminal 12 or 13 by the teller. The storage limit level determined by specifying these is set by being stored in a setting region provided in the storage portion 203. Thus, it is possible for the teller to freely set the storage limit level.

In the collective setting, the storage limit level is collectively set for the denomination-specific banknote storing portions 83. Specifically, a desired piece of information is selected from pieces of collective setting information previously stored in the storage portion 203 (a region other than the setting region), and, from the selected piece of collective setting information, the storage limit level for the denomination-specific banknote storing portions 83 is set.

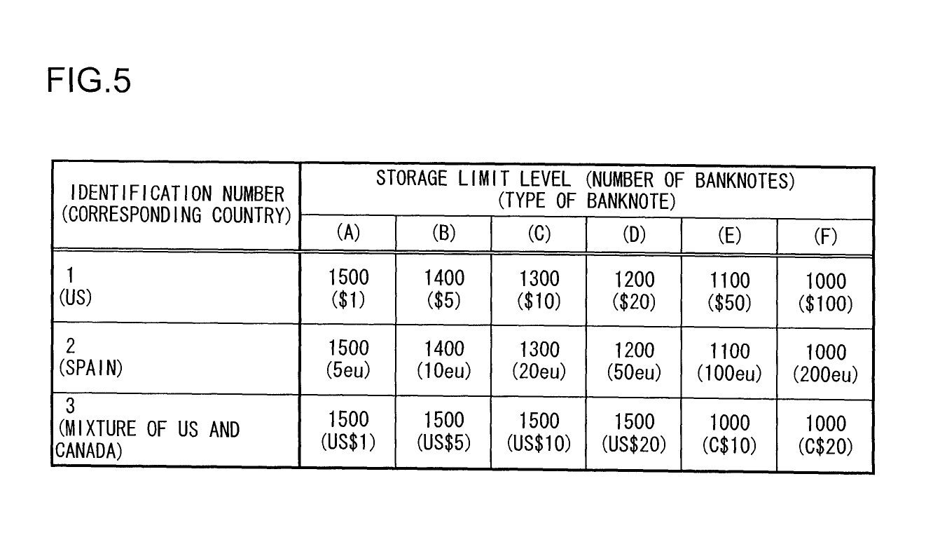

For example, as shown in FIG. 5, the collective setting information is composed of identification numbers and information on storage limit levels for the denomination-specific banknote storing portions 83. The identification number is specified through the higher-ranking terminal 12 or 13 by the teller, and the specified storage limit level included in the collective setting information is set by being stored in the setting region in the storage portion 203, with the result that it is actually used in the processing. By specifying the identification number in this way, based on the collective setting information corresponding to the identification number, the storage limit level is automatically determined for the denomination-specific banknote storing portions 83.

In FIG. 5, letters A to F represent types of denomination-specific banknote storing portions 83 (corresponding to the letters A to F in FIG. 2); for example, according to the identification number “1”, the storage limit level for the denomination-specific banknote storing portion 83 (where fifty-dollar banknotes are to be stored) represented by the letter “E” is set at 1100 banknotes. The collective setting information is so set as to be suitable when the banknote depositing and dispensing machine 11 is used in a country shown in FIG. 5.

When the storage limit level that needs to be set for each of the denomination-specific banknote storing portions 83 according to the situation is previously known, the collective setting is especially effective in that it is possible to easily set the storage limit level according to the situation. For example, the collective setting information shown in FIG. 5 corresponds to each country in which the banknote depositing and dispensing machine 11 is to be used. That is, in consideration of the types of banknotes used in the country, the thickness and usage frequency corresponding to each type of banknotes and the like, the collective setting information is previously prepared such that the banknote depositing and dispensing machine 11 is most suitable for use in the country.

In this way, for example, when the country used in the banknote depositing and dispensing machine 11 is “the U.S.”, the identification number “1” is only specified, and thus it is possible to set the storage limit level that suits the situation as much as possible for each of the denomination-specific banknote storing portions 83.

The contents of the collective setting information stored in the storage portion 203 can be changed based on information and the like transmitted from the higher-ranking terminals 12 and 13. Based on the information and the like transmitted from the higher-ranking terminals 12 and 13, a separate piece of collective setting information can be additionally stored in the storage portion 203. Thus, even when the collective setting information needs to be changed or an addition needs to be made thereto due to changes in the situation, it is possible to appropriately cope with it. Thereafter, by performing the collective setting, it is possible to reflect the details of the change and addition on the setting of the storage limit level.

As described above, the storage limit level is set based on the contents stored in the storage portion 203 (especially in the setting region). The above-described individual setting or collective setting is further changed, and thus it is possible to change the contents stored therein, with the result that the details of the setting of the storage limit level can be changed.

The details of the depositing restriction processing (step S15) described previously will be discussed.

In the depositing restriction processing, a restriction is first imposed such that banknotes are transported, from the deposited banknote escrow portion 35 to the denomination-specific banknote storing portion 83, in units of a predetermined number of banknotes (for example, in units of 100 banknotes). When this predetermined number of banknotes are stored in the denomination-specific banknote storing portion 83, and simultaneously the banknote number detection unit 201 does not detect the limitation of storage and the full-state detection unit 202 does not detect that the denomination-specific banknote storing portion 83 is full, another predetermined number of banknotes are further transported. In this way, banknotes can be prevented as much as possible from being stored in the denomination-specific banknote storing portions 83 far beyond the allowable amount.

In the depositing restriction processing, the transport of banknotes from the banknote depositing inlet 23 to the deposited banknote escrow portion 35 is interrupted. Thus, even when a restriction is imposed such that banknotes are transmitted, from the deposited banknote escrow portion 35 to the denomination-specific banknote storing portions 83, in units of a predetermined number of banknotes, the deposited banknote escrow portion 35 can be prevented as much as possible from overflowing.

When the transport of banknotes to the deposited banknote escrow portion 35 is interrupted, and simultaneously the transport of banknotes from the deposited banknote escrow portion 35 to the denomination-specific banknote storing portions 83 is continued, the number of banknotes stored in the deposited banknote escrow portion 35 is gradually reduced. When the number of banknotes stored in the deposited banknote escrow portion 35 becomes equal to or less than a predetermined number in this way, the interruption is terminated, with the result that the transport of the banknotes from the banknote depositing inlet 23 to the deposited banknote escrow portion 35 is restarted. Thus, the depositing processing is prevented as much as possible from delaying due to unsuccessful transport of banknotes to the denomination-specific banknote storing portions 83.

The details of the depositing stop processing (step S18) described above will now be discussed.

In the depositing stop processing, the transport of banknotes form the banknote depositing inlet 23 to the deposited banknote escrow portion 35 is stopped, and the transport of banknotes from the deposited banknote escrow portion 35 to the denomination-specific banknote storing portions 83 is also stopped. A banknote that is being transported is transported to the denomination-specific banknote storing portion 83 or to another location, with the result that the banknote is properly handled. In this way, banknotes can be prevented as much as possible from being additionally stored in the denomination-specific banknote storing portions 83.

In the depositing stop processing, a predetermined display (such as by a display unit or the lighting of an LED lamp) is displayed on a display device included in the banknote depositing and dispensing machine 11, and thus the teller is notified of the completion of the depositing stop processing. Alternatively or in addition to the display on the display device, the teller may be notified through a predetermined sound output from a sound device (such as a buzzer or a speaker).

Thus, it is possible for the teller to recognize the execution of the depositing stop processing, and properly handle it. Here, the banknotes left in the banknote depositing inlet 23 and the deposited banknote escrow portion 35 can be taken out by the teller, and then returned to the customer.

After the completion of the depositing stop processing (step S18), any of returning processing for returning banknotes that have already been deposited (that have been stored in the denomination-specific banknote storing portions 83) and partial depositing processing for completing the depositing processing without the banknotes being returned as described above can be freely selected and performed (according to the customer's intention).

When an instruction to perform the returning processing is given to the banknote depositing and dispensing machine 11, banknotes that have already been deposited or banknotes equivalent in value to those banknotes are fed out from the denomination-specific banknote storing portions 83 and are transported to the banknote dispensing outlet 22. The banknotes transported to the banknote dispensing outlet 22 are returned by the teller to the customer, with the result that the depositing processing is completed. By performing this returning processing, it is possible to appropriately meet the requirement of the customer or the like who considers stopping the depositing itself unless the money to be deposited has been all deposited.

On the other hand, when an instruction to perform the partial depositing processing is given, banknotes (part of the banknotes to be deposited by the customer) that have already been deposited are kept in this state, and the depositing transaction is completed. By performing this partial depositing processing, it is possible to appropriately meet the requirement of the customer or the like who wishes to deposit, if possible, part of money to be deposited.

In the processing in step S14 described above, when the full-state detection unit 202 detects the full state (yes in step S14) before the banknote number detection unit 201 detects the limitation of storage, the presently set storage limit level is corrected (step S17). Specifically, the storage limit level is corrected such that the number of banknotes which have been counted by the banknote number detection unit 201 before the full-state detection unit 202 detects the full state is set at a new storage limit level.

In this way, it is possible for the banknote number detection unit 201 to more properly detect the limitation of storage in subsequent rounds of detection. When the presently set storage limit level is set by the collective setting, the corresponding collective setting information itself may be likewise corrected.

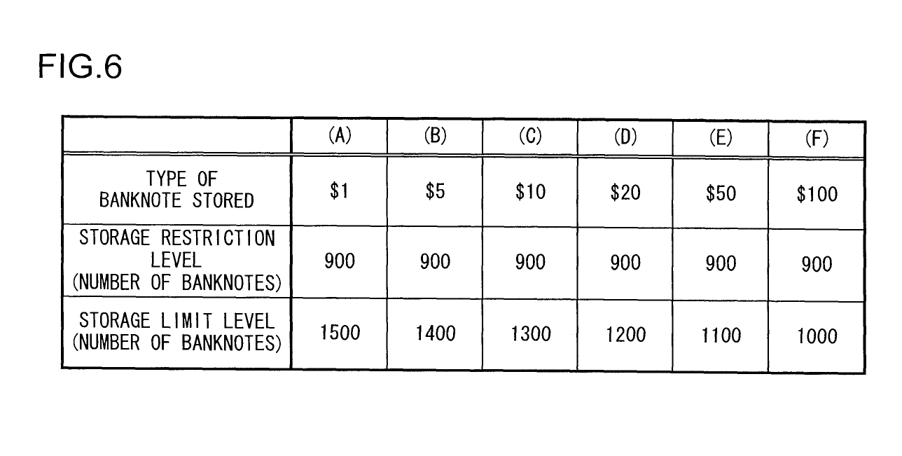

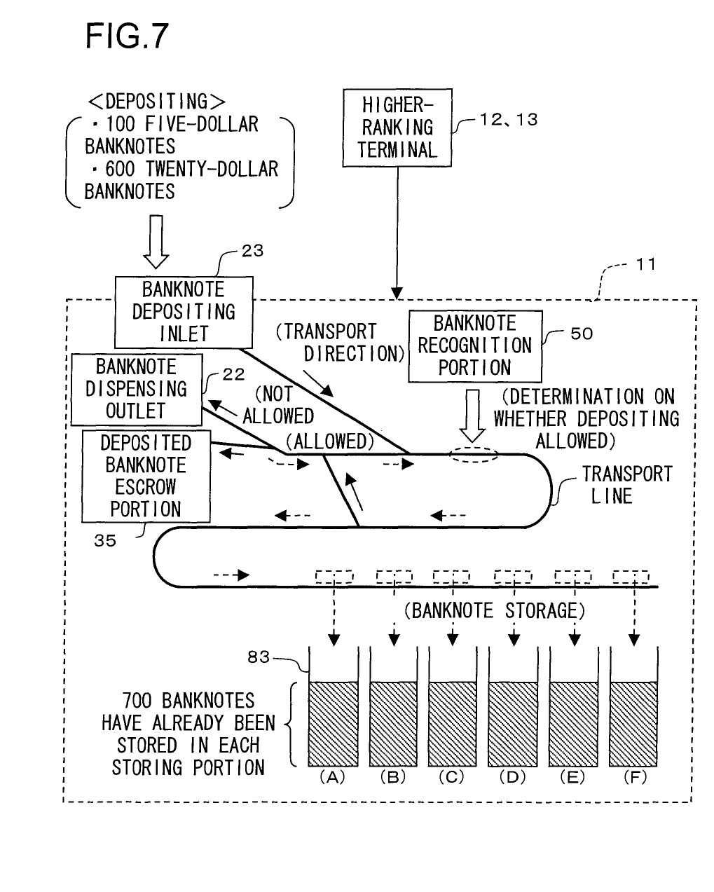

In order to make the above-described processing corresponding to the excessive storage prevention function more understandable, a specific example will be described below with reference to FIGS. 6 and 7.

In this example, it is assumed that the collective setting information shown in FIG. 5 is stored in the storage portion 203, that the identification number “1” is previously specified by the teller, and that thus the storage limit levels of the denomination-specific banknote storing portions 83 are set. The storage restriction level of each denomination-specific banknote storing portion 83 is set at 900 banknotes. Hence, the types of banknotes to be stored in the denomination-specific banknote storing portions 83, and the storage restriction levels and storage limit levels of the denomination-specific banknote storing portions 83 are listed in a table shown in FIG. 6. In the depositing restriction processing, banknotes of each denomination are transported from the deposited banknote escrow portion 35 in units of 100 banknotes.

It is assumed that, as illustrated in FIG. 7, which shows the outline of this example, 700 banknotes have already been stored in each of the denomination-specific banknote storing portions 83, and that 100 five-dollar banknotes and 600 twenty-dollar banknotes are additionally deposited.

When the above-mentioned banknotes are first put into the banknote depositing inlet 23, and an instruction to start the depositing processing is provided by the teller through the higher-ranking terminal 12 or 13, the deposited banknotes are passed through the banknote recognition portion 50 (it is assumed that all the banknotes are determined to be allowed to be deposited) and are temporarily stored in the deposited banknote escrow portion 35. Thereafter, the teller recognizes the customer's approval for the depositing, and provides a depositing approval instruction such that the banknotes are transported from the deposited banknote escrow portion 35 to the denomination-specific banknote storing portions 83 (step S11).

During this transport, the banknote number detection unit 201 continuously counts the number of banknotes transported on an individual denomination-specific banknote storing portion 83 basis (since 700 banknotes have been already stored, the counting is started with an initial value of 700), and monitors whether or not it reaches the storage restriction level and the storage limit level (steps S12 and S13). The full-state detection unit 202 likewise monitors whether or not each of the denomination-specific banknote storing portions 83 is full (step S14).

Thus, when 200 twenty-dollar banknotes (900 banknotes resulting from the addition of the initial value thereto) that are transported are counted by the banknote number detection unit 201, the depositing restriction processing is thereafter performed (step S15). Hence, in the meantime, even if banknotes are further put into the banknote depositing inlet 23, and an instruction to start the deposing processing is provided, until the number of banknotes in the deposited banknote escrow portion 35 is equal to or less than a predetermined number of banknotes, the banknotes are not transported to the deposited banknote escrow portion 35. The banknotes that have already been stored in the deposited banknote escrow portion 35 are transported to the denomination-specific banknote storing portions 83 in units of 100 banknotes.

When 500 twenty-dollar banknotes (1200 banknotes resulting from the addition of the initial value thereto) that are transported are counted by the banknote number detection unit 201 without the full state being detected, the depositing stop processing is performed (step S18). Hence, the transport of banknotes from the deposited banknote escrow portion 35 to the denomination-specific banknote storing portions 83 is also stopped.

In this state, when an instruction to perform the returning processing is provided by the teller, the banknote depositing and dispensing machine 11 transports, to the banknote dispensing outlet 22, the banknotes (composed of about 500 twenty-dollar banknotes and five-dollar banknotes that have already been stored in the denomination-specific banknote storing portion 38) that have already been stored in the denomination-specific banknote storing portion 83 in this depositing processing or banknotes equivalent in value to those banknotes. Thereafter, the teller returns, to the customer, both the banknotes that are transported and the banknotes left in the deposited banknote escrow portion 35 (about 100 twenty-dollar banknotes and five-dollar banknotes that have not yet been stored in the denomination-specific banknote storing portion 38).

On the other hand, when an instruction to perform the partial depositing processing is provided by the teller, the depositing of the banknotes that have already have been stored in the denomination-specific banknote storing portion 83 is approved (for example, the amount of money deposited is added to the deposit balance data of the customer), and the banknotes left in the deposited banknote escrow portion 35 are returned to the customer from the teller.

For example, when 350 twenty-dollar banknotes that are transported are counted by the banknote number detection unit 201 (before the storage limit level is reached), if the full-state detection unit 202 detects that the denomination-specific banknote storing portion 83 of twenty-dollar banknotes is full (yes in step S14), the depositing stop processing is performed at this point (step S18).

At this point, 1050 twenty-dollar banknotes resulting from the addition of the initial value of 700 are counted by the banknote number detection unit 201. Here, the banknote depositing and dispensing machine 11 corrects the storage limit level, which is stored in the setting region of the storage portion 203, of the denomination-specific banknote storing portion 83 indicated by letter (D) from “1200” to “1050”, and likewise corrects the collective setting information of the identification number “1” (step S17).

Although the embodiment of the present invention is described above, the invention is not limited to this embodiment, and many modifications are possible without departing from the spirit of the invention. For example, the money is not limited to banknotes; coins may be used as the money. Moreover, instead of the banknote number detection unit 201, weight detection unit may be provided that detects the weight of money that is stored in each of the denomination-specific banknote storing portions 83, and the “storage restriction level” and the “storage limit level” may be set based on weight. Thus, it is possible to realize the excessive storage prevention function in terms of weight instead of the number of banknotes.

As described above, the banknote depositing and dispensing machine 11 (money handling machine) of this embodiment has the denomination-specific banknote storing portions 83 (storing units) for storing banknotes (money), and performs the depositing processing for transporting banknotes put into (supplied to) the banknote depositing inlet 23 to the denomination-specific banknote storing portions 83 and storing therein.

For the denomination-specific banknote storing portions 83, the banknote depositing and dispensing machine 11 is provided with: limit setting unit for setting the storage limit level; storage limit determination unit for determining, when banknotes stored in the denomination-specific banknote storing portion 83 reach the storage limit level set for the denomination-specific banknote storing portion 83, the limitation of storage; and deposit stopping unit for performing depositing stop processing for stopping the depositing processing when the storage limit determination unit determines the limitation of storage.

The limit setting unit is provided with the storage portion 203 (setting storage portion) for storing the storage limit level; the limit setting unit sets the storage limit level based on contents stored in the setting storage portion and can change the setting of the storage limit level by varying the stored contents. Thus, it is possible to easily adjust, as appropriate, the storage limit level of the storing unit.

### INDUSTRIAL APPLICABILITY

The present invention can be utilized in a money handling machine and the like used in a financial institution.

1. A money handling machine that includes a storing unit for storing money and that performs depositing processing for transporting and storing supplied money in the storing unit, the money handling machine comprising:
a limit setting unit that sets a storage limit for the storing unit;
a storage limit determination unit that determines the limit of storage when the money stored in the storing unit reaches the storage limit set for the storing unit; and
a deposit stopping unit that stops the depositing processing according to a determination result obtained by the storage limit determination unit,
wherein the limit setting unit includes a setting memory portion that stores the storage limit, and performs the setting based on contents stored in the setting memory portion, and the setting can be changed by changing the stored contents.

2. A money handling machine that includes a depositing portion for receiving money, a storing unit for storing money and a transport portion for transporting money from the depositing portion to the storing unit and that transports and stores the money received by the depositing portion in the storing unit, the money handling machine comprising:
a limit setting unit that sets a storage limit for the storing unit; and
a deposit stopping unit that determines whether or not the money stored in the storing unit reaches the storage limit set for the storing unit, and that stops the transport according to a determination result,
wherein the limit setting unit includes a setting memory portion that stores the storage limit, and performs the setting based on contents stored in the setting memory portion, and the setting can be changed by changing the stored contents.

3. The money handling machine of claim 1,
wherein the storage limit determination unit counts money transported to the storing unit, and compares a counting result with the storage limit and thereby determines whether or not the storage reaches the limit.

4. The money handling machine of claim 1,
wherein the money handling machine includes a plurality of denomination-specific storing units that store the supplied money by denomination;
the limit setting unit sets the storage limit for each of the denomination-specific storing units; and
the storage limit determination unit determines the storage reaches the limit when money stored in any of the denomination-specific storing units reaches the storage limit set for the denomination-specific storing unit.

5. The money handling machine of claim 4,
wherein the limit level setting unit can operate selectively in at least any of individual setting in which the storage limit is individually set for each of the denomination-specific storing units, and collective setting in which the storage limit is collectively set for the denomination-specific storing units, to be performed.

6. The money handling machine of claim 4,
wherein the limit setting unit stores a plurality of types of collective setting information that is used for determining the storage limit for each of the denomination-specific storing units, and performs, based on any of collective setting information, collective setting in which the storage limit is collectively set for each of the denomination-specific storing units.

7. The money handling machine of claim 6, further comprising:
a communication interface that allows communication with an external device,
wherein the limit setting unit performs the collective setting based on the collective setting information, which is selected based on information transmitted from the external device.

8. The money handling machine of claim 7, further comprising:
a setting information changing portion that changes, based on the information transmitted from the external device, the collective setting information stored in the limit setting unit.

9. The money handling machine of claim 6,
wherein processing for additionally storing a set of collective setting information in the limit setting unit and processing for changing the collective setting information stored in the limit setting unit can be performed.

10. The money handling machine of claim 6,
wherein each of the plurality of types of collective setting information corresponds to a country where the money handling machine is used.

11. The money handling machine of claim 3, further comprising:
a full-state detection unit that detects a size or a weight of whole money stored in the storing unit to detect whether or not the storing unit is full.

12. The money handling machine of claim 11,
wherein the money is stored in the storing unit in a stacked manner, and the full-state detection unit detects a height of the money stacked in the storing unit to detect whether or not the storing unit is full.

13. The money handling machine of claim 11,
wherein the deposit processing is stopped when either of a condition in which the storage limit determination unit determines that the storage reaches the limit, or a condition in which the full-state detection unit detects that the storing unit is full, is satisfied.

14. The money handling machine of claim 13,
wherein, when the full-state detection unit detects the full state before the storage limit determination unit determines the storage reaches the limit, the storage limit determination unit corrects the storage limit that is set, such that the storage limit is changed to a number of pieces of or a weight of money that has been transported to the storing unit at the time the full state is detected.

15. The money handling machine of claim 1,
wherein the storage limit indicates a number of pieces of or a weight of money.

16. The money handling machine of claim 1, further comprising:
a recognition portion that recognizes whether or not the supplied money is allowed to be stored in the storing unit,
a temporary storing portion that stores money allowed by the recognition portion to be stored in the storing unit, the supplied money being transported to the temporary storing portion in the depositing processing to be temporarily stored therein and thereafter transported to the storing unit; and
a transport interruption unit that interrupts transport of the supplied money to the temporary storing portion, when a predetermined amount of money or more is stored in the storing unit and a predetermined amount of money or more is stored in the temporary storing portion.

17. The money handling machine of claim 16,
wherein the recognition portion recognizes at least a denomination of the supplied money.

18. The money handling machine of claim 16,
wherein, when the transport of the supplied money to the temporary storing portion is interrupted by the transport interruption unit, first processing for transporting and storing, in the storing unit, the money stored in the temporary storing portion, and second processing for terminating the interruption when a number of pieces of the money stored in the temporary storing portion is equal to or less than a predetermined number, are performed.

19. The money handling machine of claim 16,
wherein, when the transport of the supplied money to the temporary storing portion is interrupted by the transport interruption unit, the money handling machine performs first processing for transporting and storing, in the storing unit, the money stored in the temporary storing portion and, after the first processing is performed, third processing for providing a notification to an outside when the storage limit determination unit determines the storage reaches the limit or the full-state detection unit detects the full state.

20. The money handling machine of claim 19, further comprising:
a display device performing a display or a sound generation device generating a sound,
wherein, in the third processing, the notification is provided through the display device or the sound generation device.

21. The money handling machine of claim 16,
wherein, when the transport of the supplied money to the temporary storing portion is interrupted by the transport interruption unit, the money handling machine performs first processing for transporting and storing, in the storing unit, the money stored in the temporary storing portion and, after the first processing is performed, depositing completion processing for completing the depositing processing when the storage limit determination unit determines the storage reaches the limit or the full-state detection unit detects the full state; and, in the depositing completion processing, whether or not processing for transporting banknotes equivalent in value to banknotes that have already been stored in the storing unit to a predetermined dispensing outlet is performed is selected.

22. A method of controlling a money handling machine that includes a storing unit for storing money and that transports and stores supplied money in the storing unit, the method comprising:
a first step of setting a storage limit such that the storage limit can be changed for the storing unit;
a second step of determining whether or not the money stored in the storing unit reaches the storage limit for the storing unit; and
a third step of stopping the transport according to a determination result in the second step.
